(19) United States
(12) Patent Application Publication
(10) Pub. No.: US 2024/0411321 A1
(43) Pub. Date: Dec. 12, 2024

(54) WALL COLLISION U-TURNING METHOD FOR SWIMMING POOL CLEANING ROBOT, SWIMMING POOL EDGE CLEANING METHOD, AND ELECTRONIC DEVICE

(71) Applicant: Suzhou Smorobot Technology Co., Ltd., Suzhou City (CN)

(72) Inventor: Zhongchao DING, Beijing (CN)

(73) Assignee: Suzhou Smorobot Technology Co., Ltd., Suzhou City (CN)

(21) Appl. No.: 18/807,756

(22) Filed: Aug. 16, 2024

Related U.S. Application Data
(63) Continuation of application No. PCT/CN2022/076907, filed on Feb. 18, 2022.

(51) Int. Cl. G05D 1/648; E04H 4/16; G05D 105/10; G05D 107/00; G05D 109/30

(52) U.S. Cl. CPC G05D 1/648; E04H 4/1654; G05D 2105/10; G05D 2107/29; G05D 2109/38

(57) ABSTRACT

A wall collision U-turning method for a swimming pool cleaning robot, a swimming pool edge cleaning method, and an electronic device are provided. The wall collision U-turning method includes: controlling the swimming pool cleaning robot to move toward a wall of a swimming pool based on a preset orientation until the swimming pool cleaning robot collides with the wall of the swimming pool; controlling the swimming pool cleaning robot to move backward relative to the wall of the swimming pool until a spacing distance between the swimming pool cleaning robot and the wall of the swimming pool is sufficient for the swimming pool cleaning robot to perform a U-turn motion; and controlling the swimming pool cleaning robot to perform a U-turn relative to the wall of the swimming pool until the U-turn orientation of the swimming pool cleaning robot after completion of the U-turn is opposite to the preset orientation.

### CROSS-REFERENCE TO RELATED APPLICATION

This application is a continuation of International Application No. PCT/CN2022/076907 filed on Feb. 18, 2022, and entitled “WALL COLLISION U-TURNING METHOD AND APPARATUS FOR SWIMMING POOL CLEANING ROBOT, AND SWIMMING POOL EDGE CLEANING METHOD AND APPARATUS,” the contents of which is hereby incorporated by reference in its entirety.

### TECHNICAL FIELD

Embodiments of this disclosure relate to the technical field of swimming pool cleaning robot control, and in particular, to a wall collision U-turning method and apparatus for a swimming pool cleaning robot, a swimming pool edge cleaning method, and an electronic device.

### BACKGROUND

A swimming pool cleaning robot is a cleaning robot produced for a swimming pool cleaning need, which can repeatedly clean the bottom and walls of a swimming pool and filter water in the swimming pool.

The existing swimming pool cleaning robot has the problem of unreasonable U-turning operation after colliding with the walls when performing a swimming pool cleaning task, resulting in poor cleaning effect on the edge of the swimming pool, which affects the user experience of such products.

Therefore, an improved swimming pool wall collision U-turning control solution is needed, which can plan a more reasonable cleaning path to complete the cleaning task at the edge of the swimming pool more efficiently.

### SUMMARY

To resolve the foregoing problems, embodiments of this application provide a wall collision U-turning solution for a swimming pool cleaning robot and a swimming pool edge cleaning solution, to at least partially resolve the foregoing problems.

According to an aspect of this disclosure, a wall collision U-turning method for a swimming pool cleaning robot is provided, including: controlling the swimming pool cleaning robot to move toward a wall of a swimming pool based on a preset orientation until the swimming pool cleaning robot collides with the wall of the swimming pool (i.e., the swimming pool cleaning robot comes into contact with the wall of the swimming pool); controlling the swimming pool cleaning robot to move backward relative to the wall of the swimming pool until a spacing distance between the swimming pool cleaning robot and the wall of the swimming pool is sufficient for the swimming pool cleaning robot to perform a U-turn motion; and controlling the swimming pool cleaning robot to perform a U-turn relative to the wall of the swimming pool until the U-turn orientation of the swimming pool cleaning robot after completion of the U-turn is opposite to the preset orientation.

In one or more embodiments of the present disclosure, the controlling the swimming pool cleaning robot to move toward a wall of a swimming pool based on a preset orientation until the swimming pool cleaning robot collides with the wall of the swimming pool includes: controlling the swimming pool cleaning robot to move toward a direction of approaching the wall of the swimming pool relative to the bottom of the swimming pool based on the preset orientation until the swimming pool cleaning robot collides with the wall of the swimming pool.

In one or more embodiments of the present disclosure, after the step of controlling the swimming pool cleaning robot to collide with the wall of the swimming pool, the method further includes: detecting the position of the swimming pool cleaning robot relative to the wall of the swimming pool, and controlling the swimming pool cleaning robot to fishtail relative to the wall of the swimming pool until the position of the swimming pool cleaning robot relative to the wall of the swimming pool satisfies a preset condition when the position of the swimming pool cleaning robot relative to the wall of the swimming pool does not satisfy the preset condition.

In one or more embodiments of the present disclosure, the position of the swimming pool cleaning robot relative to the wall of the swimming pool satisfying the preset condition includes: the front side of the swimming pool cleaning robot being parallel or substantially parallel to a tangent line of the wall of the swimming pool, where the front side of the swimming pool cleaning robot is a side in the front of the swimming pool cleaning robot in a forward direction of the swimming pool cleaning robot.

In one or more embodiments of the present disclosure, the controlling the swimming pool cleaning robot to move backward relative to the wall of the swimming pool until the spacing distance between the swimming pool cleaning robot and the wall of the swimming pool is sufficient for the swimming pool cleaning robot to perform a U-turn motion includes: controlling the swimming pool cleaning robot to move backward straight relative to the wall of the swimming pool based on the posture of the swimming pool cleaning robot after colliding with the wall of the swimming pool or the posture after completion of the fishtail relative to the wall of the swimming pool.

In one or more embodiments of the present disclosure, the controlling the swimming pool cleaning robot to perform the U-turn relative to the wall of the swimming pool until the U-turn orientation of the swimming pool cleaning robot after the completion of the U-turn is opposite to the preset orientation includes: controlling the swimming pool cleaning robot to perform a differential motion based on the posture after moving backward, to perform the U-turn relative to the wall of the swimming pool until the U-turn orientation of the swimming pool cleaning robot is opposite to the preset orientation.

In one or more embodiments of the present disclosure, the controlling the swimming pool cleaning robot to perform a differential motion based on the posture after moving backward, to perform the U-turn relative to the wall of the swimming pool until the U-turn orientation of the swimming pool cleaning robot is opposite to the preset orientation includes: controlling the swimming pool cleaning robot to perform a differential forward motion based on the posture after moving backward, to perform the U-turn relative to the wall of the swimming pool; or controlling the swimming pool cleaning robot to perform a differential forward motion based on the posture after moving backward, to turn relative to the wall of the swimming pool, and controlling the swimming pool cleaning robot to perform a differential backward motion based on the posture after turning until the U-turn orientation of the swimming pool cleaning robot is opposite to the preset orientation.

In one or more embodiments of the present disclosure, the U-turn orientation of the swimming pool cleaning robot is updated as the preset orientation, and the step of controlling the swimming pool cleaning robot to move toward a wall of a swimming pool based on a preset orientation until the swimming pool cleaning robot collides with the wall of the swimming pool is continued.

According to another aspect of this disclosure, a swimming pool edge cleaning method is provided, including: controlling, based on a wall of a swimming pool corresponding to an edge position to be cleaned, a swimming pool cleaning robot to perform a wall collision U-turn motion for the wall of the swimming pool corresponding to the edge position to be cleaned, and cleaning the edge position to be cleaned during the performing of the wall collision U-turn motion, where the wall collision U-turn is performed using the wall collision U-turning method for a swimming pool cleaning robot described in the above aspect.

According to another aspect of this disclosure, a wall collision U-turning apparatus for a swimming pool cleaning robot is provided, including: a collision control module, configured to control the swimming pool cleaning robot to move toward a wall of a swimming pool based on a preset orientation until the swimming pool cleaning robot collides with the wall of the swimming pool; a backward movement control module, configured to control the swimming pool cleaning robot to move backward relative to the wall of the swimming pool until a spacing distance between the swimming pool cleaning robot and the wall of the swimming pool is sufficient for the swimming pool cleaning robot to perform a U-turn motion; and a U-turn control module, configured to control the swimming pool cleaning robot to perform the U-turn relative to the wall of the swimming pool until the U-turn orientation of the swimming pool cleaning robot after the completion of the U-turn is opposite to the preset orientation.

According to another aspect of this disclosure, a swimming pool edge cleaning apparatus is provided, including: a driving module, configured to control, based on an edge position to be cleaned, a swimming pool cleaning robot to perform a wall collision U-turn relative to a wall of a swimming pool corresponding to the edge position to be cleaned, where the wall collision U-turn is performed using the wall collision U-turning apparatus for a swimming pool cleaning robot described in the above aspect; and a cleaning module, configured to control the swimming pool cleaning robot to clean the edge position to be cleaned during the performing of the wall collision U-turn by the swimming pool cleaning robot for the wall of the swimming pool corresponding to the edge position to be cleaned.

According to another aspect of this disclosure, an electronic device is provided, including: a processor; and a memory storing a program, where the program includes instructions that, when executed by the processor, cause the processor to perform the wall collision U-turning method for a swimming pool cleaning robot or the swimming pool edge cleaning method described in the above aspect.

According to another aspect of this disclosure, a non-transitory computer-readable storage medium storing computer instructions is provided, where the computer instructions are used to cause a computer to perform the wall collision U-turning method for a swimming pool cleaning robot or the swimming pool edge cleaning method described in the above aspect. According to the wall collision U-turning method and apparatus for a swimming pool cleaning robot, the electronic device and the computer storage medium provided by this disclosure, the swimming pool cleaning robot is controlled to move backward relative to a wall of a swimming pool after colliding with the wall of the swimming pool until the spacing distance between the swimming pool cleaning robot and the wall of the swimming pool is sufficient for the swimming pool cleaning robot to perform a U-turn motion, and the swimming pool cleaning robot is controlled to perform the U-turn relative to the wall of the swimming pool. Accordingly, the swimming pool cleaning robot can be controlled to perform a safe and accurate wall collision U-turn operation, and has the advantages of simple operation and easy implementation.

In addition, the embodiments of this disclosure control the swimming pool cleaning robot to clean the edge of the swimming pool through the above wall collision U-turning solution, which can effectively improve the cleaning coverage and cleaning speed for the edge of the swimming pool.

### BRIEF DESCRIPTION OF DRAWINGS

The following drawings are intended only to schematically illustrate and explain embodiments of this disclosure and are not intended to limit the scope of this disclosure.

FIG. 1 is a schematic flowchart of a wall collision U-turning method for a swimming pool cleaning robot according to an exemplary embodiment of this disclosure;

FIG. 2 is a schematic flowchart of a wall collision U-turning method for a swimming pool cleaning robot according to another exemplary embodiment of this disclosure;

FIG. 3A to FIG. 3F are schematic diagrams of embodiments of a swimming pool cleaning robot in different wall collision U-turning stages;

FIG. 4 is a flowchart of a swimming pool edge cleaning method according to an exemplary embodiment of this disclosure;

FIG. 5 is a structural block diagram of a wall collision U-turning apparatus for a swimming pool cleaning robot according to an exemplary embodiment of this disclosure;

FIG. 6 is a structural block diagram of a swimming pool edge cleaning apparatus according to an exemplary embodiment of this disclosure; and

FIG. 7 is a structural block diagram of an electronic device according to an exemplary embodiment of this disclosure.

### REFERENCE NUMERALS

500. wall collision U-turning apparatus for swimming pool cleaning robot; 502. collision control module; 504. backward movement control module; 506. U-turn control module; 600. swimming pool edge cleaning apparatus; 602. driving module; 604. cleaning module; 700. electronic device; 701. computing unit; 702. ROM; 703. RAM; 704. bus; 705. input/output interface; 706. input unit; 707. output unit; 708. storage unit; 709. communication unit.

### DESCRIPTION OF EMBODIMENTS

To ease understanding of the technical features, objectives, and effects of the embodiments of this disclosure, embodiments of this disclosure will be described with reference to the drawings.

In this specification, “schematic” means “as an instance, example or explanation”, and any illustration or embodiment described as “schematic” herein should not be interpreted as a more preferred or advantageous technical solution.

For simplicity of the drawings, only the parts relevant to this disclosure are schematically shown in the drawings, which do not represent actual structures of products. In addition, to make the drawings simple and easy to understand, only one or more of components having the same structure or function in some drawings are schematically depicted, or only one or more of them are designated.

The U-turn operation of an existing swimming pool cleaning robot after coming into contact with a wall of a swimming pool is unreasonable, which leads to the problem of low cleaning efficiency at an edge of the swimming pool. In view of this, embodiments of this application propose an improved wall collision U-turning method and apparatus for a swimming pool cleaning robot, an improved swimming pool edge cleaning method and apparatus, an electronic device, and a computer storage medium, which can resolve the above various problems existing in the prior art.

Specific embodiments of this disclosure will be described in detail below with reference to the accompanying drawings.

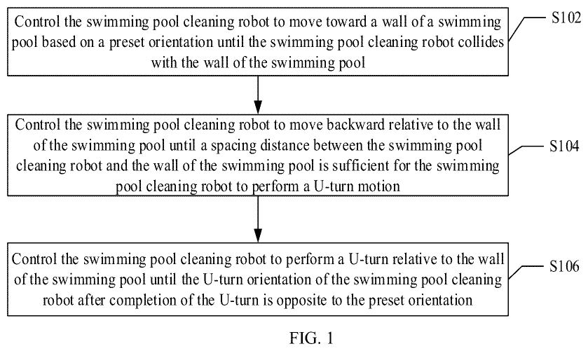

FIG. 1 is a schematic flowchart of a wall collision U-turning method for a swimming pool cleaning robot according to an exemplary embodiment of this disclosure. As shown in the figure, this embodiment mainly includes the following steps.

Step S102: Control the swimming pool cleaning robot to move toward a wall of a swimming pool based on a preset orientation until the swimming pool cleaning robot collides with the wall of the swimming pool.

In this embodiment, the swimming pool cleaning robot may be controlled to move toward a direction of approaching the wall of the swimming pool relative to the bottom of the swimming pool based on the preset orientation until the swimming pool cleaning robot collides with the wall of the swimming pool.

Step S104: Control the swimming pool cleaning robot to move backward relative to the wall of the swimming pool until the distance between the swimming pool cleaning robot and the wall of the swimming pool is sufficient for satisfy a U-turn motion of the swimming pool cleaning robot.

In one implementation, the swimming pool cleaning robot may be controlled to move backward straight (that is, without changing the orientation of the swimming pool cleaning robot) relative to the wall of the swimming pool based on the posture of the swimming pool cleaning robot after colliding with the wall of the swimming pool until the distance between the swimming pool cleaning robot and the wall of the swimming pool enables the swimming pool cleaning robot to perform a U-turn motion relative to the wall of the swimming pool.

Step S106: Control the swimming pool cleaning robot to perform a U-turn relative to the wall of the swimming pool until the U-turn orientation of the swimming pool cleaning robot after completion of the U-turn is opposite to the preset orientation.

In one implementation, the swimming pool cleaning robot may be controlled to perform a differential motion, to perform the U-turn relative to the wall of the swimming pool until the U-turn orientation of the swimming pool cleaning robot after the U-turn is opposite to the preset orientation.

To sum up, in the wall collision U-turning method for a swimming pool cleaning robot according to the embodiment of this disclosure, the swimming pool cleaning robot is controlled to move backward relative to a wall of a swimming pool after colliding with the wall, so that the swimming pool cleaning robot can smoothly perform a U-turn relative to the wall of the swimming pool. Accordingly, the swimming pool cleaning robot can be controlled to quickly and accurately perform a wall collision U-turn operation, and has the advantages of simple operation steps and high safety.

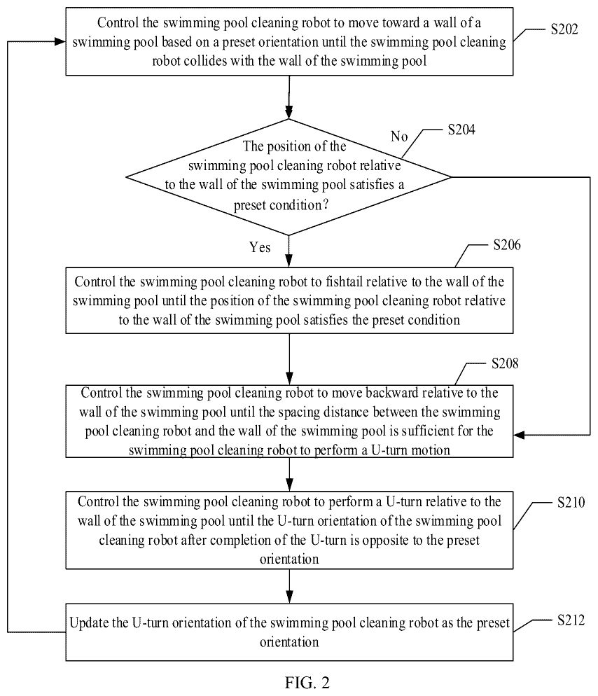

FIG. 2 is a processing flowchart of a wall collision U-turning method for a swimming pool cleaning robot according to another exemplary embodiment of this disclosure. As shown in the figure, this embodiment mainly includes the following processing steps.

Step S202: Control the swimming pool cleaning robot to move toward a wall of a swimming pool based on a preset orientation until the swimming pool cleaning robot collides with the wall of the swimming pool.

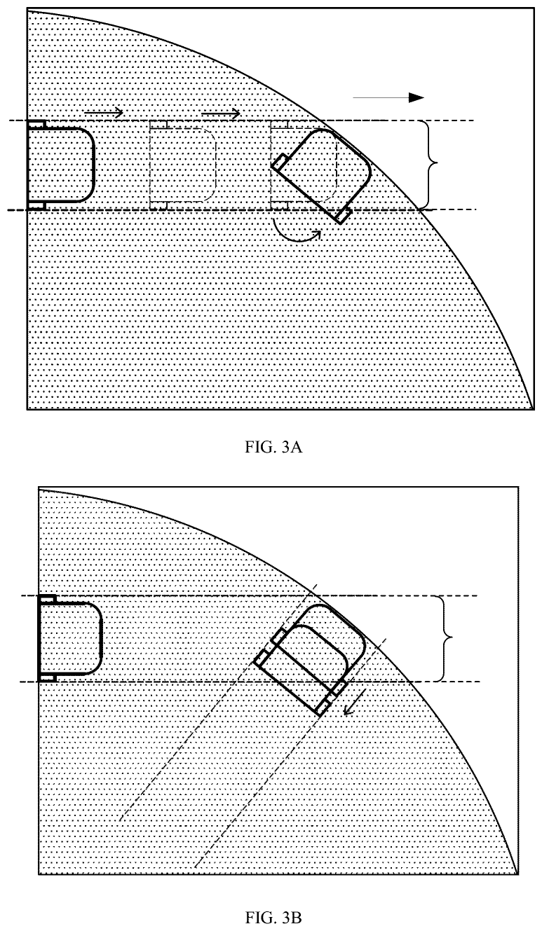

For example, with reference to FIG. 3A, the swimming pool cleaning robot may be driven to move toward a direction of approaching the wall of the swimming pool relative to the bottom of the swimming pool along a first cleaning path S1 based on the F1 direction, until the front side of the swimming pool cleaning robot collides with the wall of the swimming pool.

In this embodiment, the front side of the swimming pool cleaning robot refers to a side in the front of the swimming pool cleaning robot in a forward direction of the swimming pool cleaning robot.

Step S204: Determine whether the position of the swimming pool cleaning robot relative to the wall of the swimming pool satisfies a preset condition, if so, perform step S208, otherwise, perform step S206.

In one implementation, the wall of the swimming pool includes a planar wall or an arc wall.

In this embodiment, in the case where the wall of the swimming pool is a planar wall, when the front side of the swimming pool cleaning robot is parallel or substantially parallel to the wall of the swimming pool, or the left and right ends of the front side of the swimming pool cleaning robot abut against the wall of the swimming pool, it indicates that the position of the swimming pool cleaning robot relative to the wall of the swimming pool satisfies the preset condition.

In this embodiment, in the case where the wall of the swimming pool is an arc wall, when the front side of the swimming pool cleaning robot is parallel or substantially parallel to a tangent line of the wall of the swimming pool, or the left and right ends of the front side of the swimming pool cleaning robot abut against the wall of the swimming pool, it indicates that the position of the swimming pool cleaning robot relative to the wall of the swimming pool satisfies the preset condition (refer to the state shown in FIG. 3A).

Step S206: Control the swimming pool cleaning robot to fishtail relative to the wall of the swimming pool until the position of the swimming pool cleaning robot relative to the wall of the swimming pool satisfies the preset condition.

In this embodiment, the swimming pool cleaning robot can fishtail relative to the wall of the swimming pool by means of its own moving inertia, or a driving force can be applied to the swimming pool cleaning robot, to control the swimming pool cleaning robot to fishtail relative to the wall of the swimming pool.

For example, when the wall of the swimming pool is a planar wall or an arc wall having a relatively small radian, if the angle between the swimming pool cleaning robot and the wall of the swimming pool is relatively large when colliding with the wall of the swimming pool, and the swimming pool cleaning robot fishtails relative to the wall of the swimming pool only by means of its own moving inertia, the position of the swimming pool cleaning robot relative to the wall of the swimming pool may not satisfy the preset condition. In this case, a driving force can be applied to the swimming pool cleaning robot, to control the swimming pool cleaning robot to fishtail relative to the wall of the swimming pool until the position of the swimming pool cleaning robot relative to the wall of the swimming pool satisfies the preset condition.

For another example, in the case where the wall of the swimming pool is an arc wall having a relatively large radian, if the swimming pool cleaning robot fishtails relative to the wall of the swimming pool only by means of its own moving inertia, the position of the swimming pool cleaning robot relative to the wall of the swimming pool may also not satisfy the preset condition. In this case, a driving force can also be applied to the swimming pool cleaning robot, to control the swimming pool cleaning robot to fishtail relative to the wall of the swimming pool.

Specifically, the front side angle of the swimming pool cleaning robot colliding with the wall of the swimming pool (the front side angle refers to a side angle of the front side of the swimming pool cleaning robot) can be used as a fulcrum, and a driving force can be applied to the swimming pool cleaning robot, to control the swimming pool cleaning robot to fishtail relative to the wall of the swimming pool based on the fulcrum until the position of the front side of the swimming pool cleaning robot relative to the wall of the swimming pool satisfies the preset condition (refer to the state shown in FIG. 3A).

Step S208: Control the swimming pool cleaning robot to move backward relative to the wall of the swimming pool until the spacing distance between the swimming pool cleaning robot and the wall of the swimming pool is sufficient for the swimming pool cleaning robot to perform a U-turn motion.

In one or more embodiments of the present disclosure, the swimming pool cleaning robot may be controlled to move backward straight (refer to the state shown in FIG. 3) relative to the wall of the swimming pool based on the posture of the swimming pool cleaning robot after completion of the fishtail relative to the wall of the swimming pool until the spacing distance between the swimming pool cleaning robot and the wall of the swimming pool is sufficient for the swimming pool cleaning robot to perform the U-turn motion.

For example, the backward distance can be set based on the rotation radius of the swimming pool cleaning robot, and the swimming pool cleaning robot can be driven to move backward straight (that is, without changing the orientation of the swimming pool cleaning robot) relative to the wall of the swimming pool based on the set backward distance until the actual backward distance of the swimming pool cleaning robot satisfies the set backward distance.

Step S210: Control the swimming pool cleaning robot to perform the U-turn relative to the wall of the swimming pool until the U-turn orientation of the swimming pool cleaning robot after completion of the U-turn is opposite to the preset orientation.

In one implementation, the swimming pool cleaning robot can be controlled to perform the U-turn relative to the wall of the swimming pool based on a posture after moving backward and a preset radian, until the U-turn orientation of the swimming pool cleaning robot is opposite to the preset orientation (for example, the F2 direction shown in FIG. 3F).

In one implementation, while performing the U-turn operation, the swimming pool cleaning robot can also move from the current cleaning path to an adjacent cleaning path.

In an embodiment, the swimming pool cleaning robot can be controlled to perform a differential forward motion based on the posture after moving backward, to perform the U-turn relative to the wall of the swimming pool (refer to the states shown in FIGS. 3C, 3D, and 3F) until the U-turn orientation of the swimming pool cleaning robot is opposite to the preset orientation (for example, the F2 direction shown in FIG. 3F), and the swimming pool cleaning robot moves from the first cleaning path (for example, the first cleaning path S1 shown in FIG. 3A) to the second cleaning path (for example, the second cleaning path S2 shown in FIG. 3F) adjacent to the first cleaning path. With the technical means of this embodiment, the swimming pool cleaning robot can quickly U-turn and switch paths, so as to improve the execution efficiency of wall collision U-turn of the swimming pool cleaning robot while ensuring the wall collision U-turn safety.

In another embodiment, the swimming pool cleaning robot can be controlled to perform a differential forward motion based on the posture after moving backward to turn relative to the wall of the swimming pool (refer to the states shown in FIGS. 3C, 3D and 3E), the swimming pool cleaning robot can be controlled to perform a differential backward motion based on the posture after turning (for example, the state shown in FIG. 3E) until the turning orientation of the swimming pool cleaning robot is opposite to the preset orientation, and the swimming pool cleaning robot is aligned with the second cleaning path S2, for example, the central axis of the swimming pool cleaning robot coincides or substantially coincides with the central axis of the second cleaning path S2 (refer to the states shown in FIGS. 3E and 3F). With the technical means of this embodiment, the swimming pool cleaning robot can U-turn and switch paths more accurately in a relatively small space, and the width of the cleaning path can be designed to be the same as the body width of the swimming pool cleaning robot, so as to increase the contact coverage between the swimming pool cleaning robot and the bottom and walls of the swimming pool.

Step S212: Update the U-turn orientation of the swimming pool cleaning robot as the preset orientation, and return to step S202.

For example, the preset orientation of the swimming pool cleaning robot can be updated from the F1 direction shown in FIG. 3A to the F2 direction shown in FIG. 3F, and the swimming pool cleaning robot can be controlled to move along the second cleaning path S2 based on the F2 direction, so as to perform next wall collision U-turn operation (refer to the state shown in FIG. 3F).

In one implementation, the swimming pool cleaning robot can be controlled to move backward based on the updated preset orientation until the swimming pool cleaning robot collides with the wall of the swimming pool, and then step S202 is performed.

Specifically, after the preset orientation is updated to the F2 direction shown in FIG. 3F, the swimming pool cleaning robot can be controlled to move backward straight along the second cleaning path S2 until the swimming pool cleaning robot collides with the wall of the swimming pool at one end of the second cleaning path S2 (for example, collides with the wall of the swimming pool at the rear end of the second cleaning path S2 shown in FIG. 3F), and then step S202 is performed, to control the swimming pool cleaning robot to move forward straight along the second cleaning path S2 until the swimming pool cleaning robot collides with the wall of the swimming pool at the other end of the second cleaning path S2 (for example, collides with the wall of the swimming pool at the left end of the second cleaning path S2 shown in FIG. 3F), so that the swimming pool cleaning robot is in effective contact with the walls of the swimming pool at the two opposite ends of the second cleaning path S2.

To sum up, according to the wall collision U-turning method for a swimming pool cleaning robot provided by the embodiment of this disclosure, a fishtailing operation is added after the swimming pool cleaning robot collides with a wall, and the swimming pool cleaning robot moves backward and U-turns based on the posture after swinging its tail, so that the swimming pool cleaning robot can complete the wall collision U-turn more accurately and safely, which is particularly suitable for the wall collision U-turn operation of an arc pool wall. In addition, after the swimming pool cleaning robot completes the wall collision U-turn operation, an operation of moving backward against the wall is added, so that the swimming pool cleaning robot can achieve effective contact with the walls of the swimming pools at two opposite ends of each cleaning path, to improve the contact coverage between the swimming pool cleaning robot and the wall of the swimming pool.

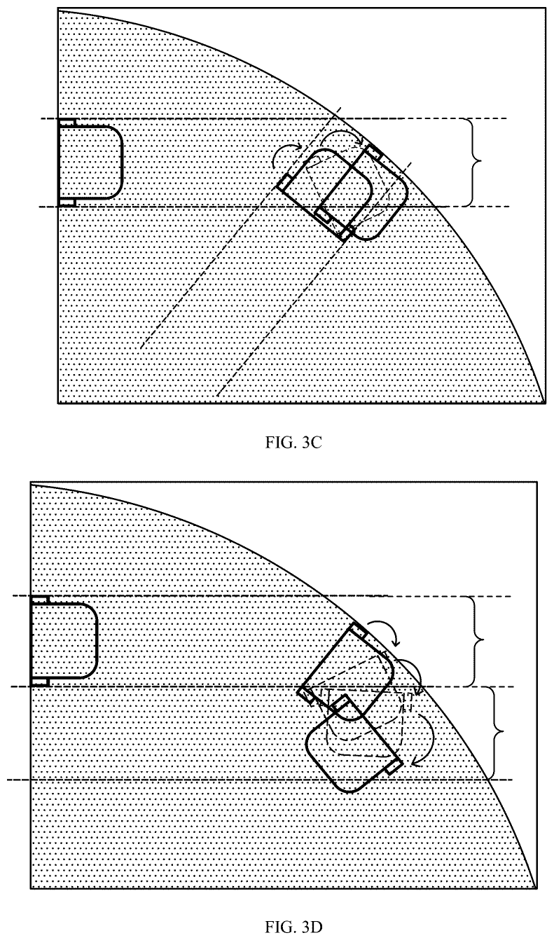

FIG. 4 illustrates a processing flowchart of a swimming pool edge cleaning method according to an exemplary embodiment of this disclosure. As shown in the figure, this embodiment mainly includes the following steps.

Step S402: Based on an edge position to be cleaned, control a swimming pool cleaning robot to perform a wall collision U-turn relative to a wall of a swimming pool corresponding to the edge position to be cleaned.

In this embodiment, the swimming pool cleaning robot can be controlled to perform the wall collision U-turn relative to the wall of the swimming pool corresponding to the edge position to be cleaned based on the wall collision U-turning method for a swimming pool cleaning robot described in the above embodiments.

Step S404: Control the swimming pool cleaning robot to clean the edge position to be cleaned during the wall collision U-turn.

To sum up, the embodiment of this disclosure can improve the cleaning efficiency of swimming pool edges by controlling a swimming pool cleaning robot to perform a cleaning task of the swimming pool edges based on the wall collision U-turning solution described in the foregoing embodiments.

Specifically, the swimming pool cleaning robot can perform a fast and safe wall collision operation by using the wall collision U-turning solution described in the foregoing embodiments, to improve the cleaning speed of the swimming pool edges.

In addition, the swimming pool cleaning robot is controlled to fishtail after colliding with the arc wall, which can increase the contact area between the swimming pool cleaning robot and the arc edge and is particularly suitable for the cleaning of arc-shaped swimming pool edges.

Moreover, the combination of differential forward motion and differential backward motion enables the swimming pool cleaning robot to accurately switch paths, and the operation of moving backward against the wall after the U-turn is completed enables the swimming pool cleaning robot to achieve effective contact with the walls of the swimming pools at the two ends of each cleaning path, to effectively improve the cleaning coverage of the swimming pool edges.

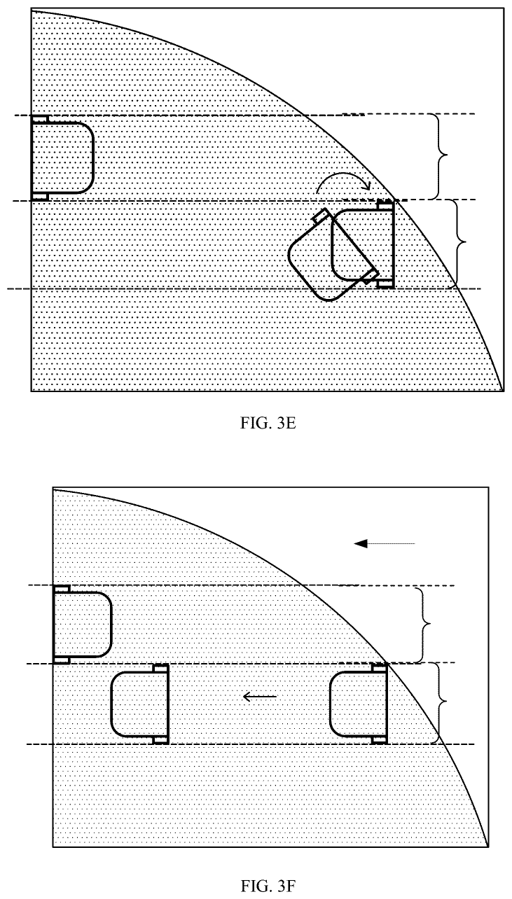

FIG. 5 illustrates a structural block diagram of a wall collision U-turning apparatus for a swimming pool cleaning robot according to an exemplary embodiment of this disclosure. As shown in the figure, the wall collision U-turning apparatus 500 for the swimming pool cleaning robot in this embodiment includes a collision control module 502, a backward movement control module 504, and a U-turn control module 506.

The collision control module 502 is configured to control the swimming pool cleaning robot to move toward a wall of a swimming pool based on a preset orientation until the swimming pool cleaning robot collides with the wall of the swimming pool.

The backward movement control module 504 is configured to control the swimming pool cleaning robot to move backward relative to the wall of the swimming pool until the spacing distance between the swimming pool cleaning robot and the wall of the swimming pool is sufficient for the swimming pool cleaning robot to perform a U-turn motion.

The U-turn control module 506 is configured to control the swimming pool cleaning robot to perform a U-turn relative to the wall of the swimming pool until the U-turn orientation of the swimming pool cleaning robot after completion of the U-turn is opposite to the preset orientation.

In one implementation, the collision control module 502 is further configured to: control the swimming pool cleaning robot to move toward a direction of approaching the wall of the swimming pool relative to the bottom of the swimming pool based on the preset orientation until the swimming pool cleaning robot collides with the wall of the swimming pool.

In one implementation, the collision control module 502 is further configured to: detect the position of the swimming pool cleaning robot relative to the wall of the swimming pool after the swimming pool cleaning robot collides with the wall of the swimming pool, and if the position of the swimming pool cleaning robot relative to the wall of the swimming pool does not satisfy a preset condition, control the swimming pool cleaning robot to fishtail relative to the wall of the swimming pool until the position of the swimming pool cleaning robot relative to the wall of the swimming pool satisfies the preset condition.

In one implementation, the position of the swimming pool cleaning robot relative to the wall of the swimming pool satisfying the preset condition includes: the front side of the swimming pool cleaning robot being parallel or substantially parallel to a tangent line of the wall of the swimming pool, where the front side of the swimming pool cleaning robot is a side in the front of the swimming pool cleaning robot in a forward direction of the swimming pool cleaning robot.

In one implementation, the backward movement control module 504 is further configured to: control the swimming pool cleaning robot to move backward straight relative to the wall of the swimming pool based on the posture of the swimming pool cleaning robot after colliding with the wall of the swimming pool or the posture after completion of the fishtail relative to the wall of the swimming pool.

In one implementation, the U-turn control module 506 is further configured to: control the swimming pool cleaning robot to perform a differential motion based on the posture after moving backward, to perform the U-turn relative to the wall of the swimming pool until the U-turn orientation of the swimming pool cleaning robot is opposite to the preset orientation.

In one implementation, the U-turn control module 506 is further configured to: control the swimming pool cleaning robot to perform a differential forward motion based on the posture after moving backward, to perform the U-turn relative to the wall of the swimming pool; or control the swimming pool cleaning robot to perform a differential forward motion based on the posture after moving backward, to turn relative to the wall of the swimming pool, and control the swimming pool cleaning robot to perform a differential backward motion based on the posture after turning until the U-turn orientation of the swimming pool cleaning robot is opposite to the preset orientation.

In one implementation, the U-turn control module 506 is further configured to: update the U-turn orientation of the swimming pool cleaning robot as the preset orientation, and trigger the collision control module 502 to continue the step of controlling the swimming pool cleaning robot to move toward a wall of a swimming pool based on a preset orientation until the swimming pool cleaning robot collides with the wall of the swimming pool.

In one implementation, the wall collision U-turning apparatus 500 for the swimming pool cleaning robot according to the embodiment of this disclosure can also be configured to implement other steps in the foregoing embodiments of the wall collision U-turning method for the swimming pool cleaning robot, and has the beneficial effects of the corresponding method step embodiments, which will not be repeated here.

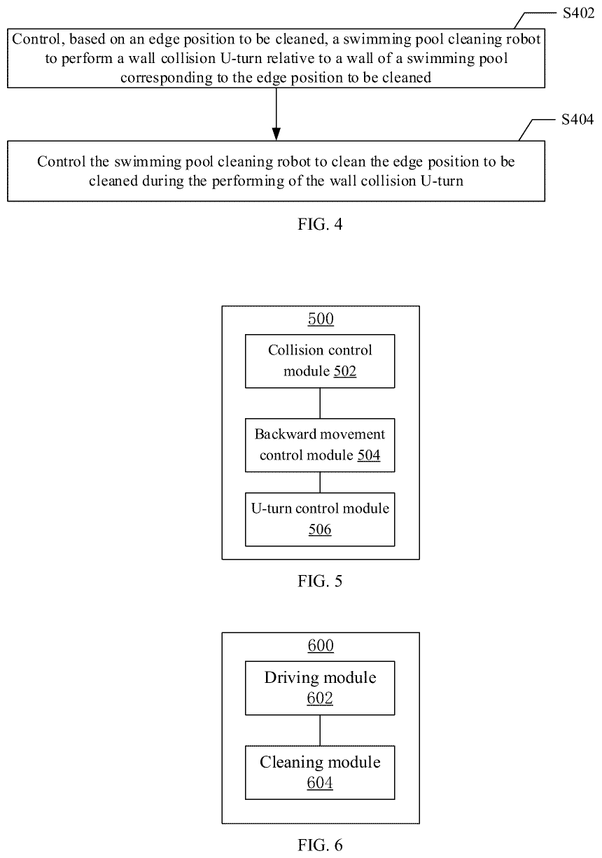

FIG. 6 illustrates a structural block diagram of a swimming pool edge cleaning apparatus according to an exemplary embodiment of this disclosure. As shown in the figure, the swimming pool edge cleaning apparatus 600 in this embodiment mainly includes: a driving module 602 and a cleaning module 604.

The driving module 602 is configured to, based on an edge position to be cleaned, control a swimming pool cleaning robot to perform a wall collision U-turn relative to a wall of a swimming pool corresponding to the edge position to be cleaned.

In this embodiment, the driving module 602 may use the above-mentioned wall collision U-turning apparatus for a swimming pool cleaning robot to perform the wall collision U-turn of the swimming pool cleaning robot.

The cleaning module 604 is configured to control the swimming pool cleaning robot to clean the edge position to be cleaned during the wall collision U-turn.

In addition, the swimming pool edge cleaning apparatus 600 according to the embodiment of this disclosure can also be configured to implement other steps in the foregoing embodiments of the swimming pool edge cleaning method, and has the beneficial effects of the corresponding method steps, which will not be repeated here.

An exemplary embodiment of this disclosure further provides an electronic device, including: at least one processor; and a memory in communication connection with the at least one processor. The memory stores a computer program executable by the at least one processor, the computer program being used to cause the electronic device to perform the methods according to the embodiments of this disclosure when executed by the at least one processor.

An exemplary embodiment of this disclosure further provides a non-transitory computer-readable storage medium storing a computer program, where the computer program, when executed by a processor of a computer, is used to cause the computer to perform the methods according to the embodiments of this disclosure.

An exemplary embodiment of this disclosure further provides a computer program product, including a computer program, where the computer program, when executed by a processor of a computer, is used to cause the computer to perform the methods according to the embodiments of this disclosure.

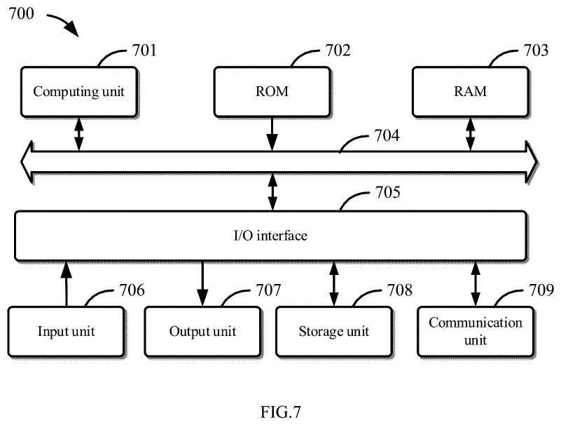

With reference to FIG. 7, a structural block diagram of an electronic device 700 that can serve as a server or a client terminal of this disclosure will now be described, which is an example of a hardware device that can be applied to various aspects of this disclosure. The electronic device is intended to represent various forms of digital electronic computer devices, such as a laptop, a desktop, a worktable, a personal digital assistant, a server, a blade server, a mainframe computer, and other suitable computers. The electronic device may also represent various forms of mobile devices, such as a personal digital assistant, a cellular phone, a smart phone, a wearable device, and other similar computing devices. For components shown herein, their connections and relationships, and their functions are by way of example only, and are not intended to limit implementations of this disclosure described and/or claimed herein.

As shown in FIG. 7, the electronic device 700 includes a computing unit 701, which may perform various appropriate operations and processes based on computer programs stored in a read-only memory (ROM) 702 or computer programs loaded from a storage unit 708 to a random access memory (RAM) 703. The RAM 703 may also store various programs and data required by the operations of the device 700. The computing unit 701, the ROM 702, and the RAM 703 are connected to each other by a bus 704. An input/output (I/O) interface 705 is also connected to the bus 704.

A plurality of components in the electronic device 700 is connected to the I/O interface 705, including: an input unit 706, an output unit 707, a storage unit 708, and a communication unit 709. The input unit 706 may be any type of device capable of inputting information to the electronic device 700, and the input unit 706 may receive input numerical or character information and generate key signal input related to user settings and/or function control of the electronic device. The output unit 707 may be any type of device capable of presenting information, and may include, but is not limited to, a display, a speaker, a video/audio output terminal, a vibrator, and/or a printer. The storage unit 704 may include, but is not limited to, a magnetic disk and an optical disk. The communication unit 709 allows the electronic device 700 to exchange information/data with other devices through computer networks such as the Internet and/or various telecommunication networks, and may include, but is not limited to, a modem, a network card, an infrared communication device, a wireless communication transceiver and/or a chipset, such as a Bluetooth™ device, a WiFi device, a WiMax device, a cellular communication device and/or the like.

The computing unit 701 may be a variety of general-purpose and/or dedicated processing components with processing and computing capabilities. Some examples of the computing unit 701 include, but are not limited to, a central processing unit (CPU), a graphics processing unit (GPU), various specialized artificial intelligence (AI) computing chips, various computing units that run machine learning model algorithms, a digital signal processor (DSP), and any suitable processor, controller, microcontroller, etc. The computing unit 701 performs the various methods and processes described above. For example, in some embodiments, the wall collision U-turning method for a swimming pool cleaning robot and the swimming pool edge cleaning method in the foregoing embodiments may be implemented as computer software programs tangibly included in a machine-readable medium, such as the storage unit 708. In some embodiments, part or all of the computer program may be loaded and/or installed to the electronic device 700 via the ROM 702 and/or the communication unit 709. In some embodiments, the computing unit 701 may be configured to perform the wall collision U-turning method for a swimming pool cleaning robot and the swimming pool edge cleaning method by any other suitable means (for example, by means of firmware).

Program codes for implementing the methods of this disclosure may be written in one programming language or any combination of more programming languages. The program codes may be provided to a processor or controller of a general purpose computer, a special purpose computer or other programmable data processing apparatus, so that the program codes, when executed by the processor or controller, cause the functions/operations specified in the flowcharts and/or block diagrams to be implemented. The program codes may be completely executed on a machine, partially executed on a machine, partially executed on a machine and partially executed on a remote machine as a separate software package, or completely executed on a remote machine or a server.

In the context of this disclosure, the machine-readable medium may be a tangible medium that may include or store programs used by an instruction execution system, apparatus or device or used with the instruction execution system, apparatus or device. The machine-readable medium may be a machine-readable signal medium or a machine-readable storage medium. The machine-readable medium may include, but is not limited to, electric, magnetic, optical, electromagnetic, infrared, or semiconductor systems, apparatuses, devices, or a combination of any of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), a fiber, a portable compact disk read-only memory (CD-ROM), an optical memory, a magnet memory, or any suitable combination of the above.

As used in this disclosure, the terms “machine-readable medium” and “computer-readable medium” refer to any computer program product, device, and/or apparatus (for example, a magnetic disk, an optical disk, a memory, and a programmable logic device (PLD)) for providing machine instructions and/or data to a programmable processor, including a machine-readable medium that receives machine instructions as machine-readable signals. The term “machine-readable signal” refers to any signal used to provide machine instructions and/or data to the programmable processor.

To provide interaction with a user, the system and technology described herein may be implemented on a computer, the computer including: a display device (for example, a CRT (cathode ray tube) or LCD (liquid crystal display) monitor) for displaying information to the user); and a keyboard and a pointing device (for example, a mouse or a trackball) through which the user can provide input to the computer. Other types of devices may also be used to provide interaction with the user, for example, the feedback provided to the user may be any form of sensory feedback (for example, visual feedback, auditory feedback, or tactile feedback); and may be in any form (including acoustic input, voice input, or tactile input) to receive input from the user.

The system and technology described herein may be implemented on a computing system including back-end components (for example, serving as a data server), or a computing system including middleware components (for example, an application server), or a computing system including front-end components (for example, a user computer having a graphical user interface or a web browser through which the user can interact with the embodiments of the system and technology described herein), or a computing system including any combination of such back-end components, middleware components, or front-end components. The components of the system may be interconnected by any form or medium of digital data communication (for example, a communication network). Examples of the communication network include: a Local Area Network (LAN), a Wide Area Network (WAN), and the Internet.

The computer system may include a client and a server. The client and the server are generally remote from each other and usually interact through a communication network. The relationship between the client and the server is generated by virtue of computer programs running on corresponding computers and having a client-server relationship to each other.

It should be understood that although this specification is described in accordance with various embodiments, each embodiment does not contain only one independent technical solution. Such a description manner of the specification is merely intended for the sake of clarity and the specification should be taken as a whole by those skilled in the art. The technical solutions in the various embodiments may be suitably combined to form other implementations that may be understood by those skilled in the art.

The foregoing descriptions are merely schematic implementations of the embodiments of this disclosure, and are not construed as a limitation on the scope of the embodiments of this disclosure. Any equivalent changes, modifications and combinations made by those skilled in the art without departing from the concepts and principles of the embodiments of this disclosure shall fall within the scope of protection of the embodiments of this disclosure.

1. A wall collision U-turning method for a swimming pool cleaning robot, comprising:
controlling the swimming pool cleaning robot to move toward a wall of a swimming pool based on a preset orientation until the swimming pool cleaning robot collides with the wall of the swimming pool;
controlling the swimming pool cleaning robot to move backward relative to the wall of the swimming pool until a spacing distance between the swimming pool cleaning robot and the wall of the swimming pool is sufficient for the swimming pool cleaning robot to perform a U-turn motion; and
controlling the swimming pool cleaning robot to perform a U-turn relative to the wall of the swimming pool until a U-turn orientation of the swimming pool cleaning robot after completion of the U-turn is opposite to the preset orientation.

2. The method according to claim 1, wherein the controlling the swimming pool cleaning robot to move toward the wall of the swimming pool based on the preset orientation until the swimming pool cleaning robot collides with the wall of the swimming pool comprises:
controlling the swimming pool cleaning robot to move toward a direction of approaching the wall of the swimming pool relative to a bottom of the swimming pool based on the preset orientation until the swimming pool cleaning robot collides with the wall of the swimming pool.

3. The method according to claim 2, wherein after the step of controlling the swimming pool cleaning robot to collide with the wall of the swimming pool, the method further comprises:
detecting a position of the swimming pool cleaning robot relative to the wall of the swimming pool; and
when the position of the swimming pool cleaning robot relative to the wall of the swimming pool does not satisfy a preset condition, controlling the swimming pool cleaning robot to fishtail relative to the wall of the swimming pool until the position of the swimming pool cleaning robot relative to the wall of the swimming pool satisfies the preset condition.

4. The method according to claim 3, wherein the position of the swimming pool cleaning robot relative to the wall of the swimming pool satisfying the preset condition comprises:
a front side of the swimming pool cleaning robot being parallel or substantially parallel to a tangent line of the wall of the swimming pool, wherein the front side of the swimming pool cleaning robot is a side in the front of the swimming pool cleaning robot in a forward direction of the swimming pool cleaning robot.

5. The method according to claim 2, wherein the controlling the swimming pool cleaning robot to move backward relative to the wall of the swimming pool until the spacing distance between the swimming pool cleaning robot and the wall of the swimming pool is sufficient for the swimming pool cleaning robot to perform the U-turn motion comprises:
controlling the swimming pool cleaning robot to move backward straight relative to the wall of the swimming pool based on a posture of the swimming pool cleaning robot after colliding with the wall of the swimming pool or the posture after completion of the fishtail relative to the wall of the swimming pool.

6. The method according to claim 1, wherein the controlling the swimming pool cleaning robot to perform the U-turn relative to the wall of the swimming pool until the U-turn orientation of the swimming pool cleaning robot after the completion of the U-turn is opposite to the preset orientation comprises:
controlling the swimming pool cleaning robot to perform a differential motion based on a posture after moving backward, to perform the U-turn relative to the wall of the swimming pool until the U-turn orientation of the swimming pool cleaning robot is opposite to the preset orientation.

7. The method according to claim 6, wherein the controlling the swimming pool cleaning robot to perform the differential motion based on the posture after moving backward, to perform the U-turn relative to the wall of the swimming pool until the U-turn orientation of the swimming pool cleaning robot is opposite to the preset orientation comprises:
controlling the swimming pool cleaning robot to perform a differential forward motion based on the posture after moving backward, to perform the U-turn relative to the wall of the swimming pool; or
controlling the swimming pool cleaning robot to perform the differential forward motion based on the posture after moving backward, to turn relative to the wall of the swimming pool, and controlling the swimming pool cleaning robot to perform a differential backward motion based on a posture after turning until the U-turn orientation of the swimming pool cleaning robot is opposite to the preset orientation.

8. The method according to claim 1, wherein the method further comprises:
updating the U-turn orientation of the swimming pool cleaning robot as the preset orientation; and
returning to and continuing with the step of controlling the swimming pool cleaning robot to move toward the wall of the swimming pool based on the preset orientation until the swimming pool cleaning robot collides with the wall of the swimming pool.

9. A swimming pool edge cleaning method, comprising:
controlling, based on a wall of a swimming pool corresponding to an edge position to be cleaned, a swimming pool cleaning robot to perform a wall collision U-turn motion for the wall of the swimming pool corresponding to the edge position to be cleaned; and
cleaning the edge position to be cleaned during the performing of the wall collision U-turn motion,
wherein the wall collision U-turn motion is performed using a wall collision U-turning method for the swimming pool cleaning robot, the wall collision U-turning method comprising:
controlling the swimming pool cleaning robot to move toward the wall of the swimming pool based on a preset orientation until the swimming pool cleaning robot collides with the wall of the swimming pool;
controlling the swimming pool cleaning robot to move backward relative to the wall of the swimming pool until a spacing distance between the swimming pool cleaning robot and the wall of the swimming pool is sufficient for the swimming pool cleaning robot to perform a U-turn motion; and
controlling the swimming pool cleaning robot to perform a U-turn relative to the wall of the swimming pool until a U-turn orientation of the swimming pool cleaning robot after completion of the U-turn is opposite to the preset orientation.

10. The swimming pool edge cleaning method according to claim 9, wherein the controlling the swimming pool cleaning robot to move toward the wall of the swimming pool based on the preset orientation until the swimming pool cleaning robot collides with the wall of the swimming pool comprises:
controlling the swimming pool cleaning robot to move toward a direction of approaching the wall of the swimming pool relative to a bottom of the swimming pool based on the preset orientation until the swimming pool cleaning robot collides with the wall of the swimming pool.

11. The swimming pool edge cleaning method according to claim 10, wherein after the step of controlling the swimming pool cleaning robot to collide with the wall of the swimming pool, the method further comprises:
detecting a position of the swimming pool cleaning robot relative to the wall of the swimming pool; and
when the position of the swimming pool cleaning robot relative to the wall of the swimming pool does not satisfy a preset condition, controlling the swimming pool cleaning robot to fishtail relative to the wall of the swimming pool until the position of the swimming pool cleaning robot relative to the wall of the swimming pool satisfies the preset condition.

12. The swimming pool edge cleaning method according to claim 11, wherein the position of the swimming pool cleaning robot relative to the wall of the swimming pool satisfying the preset condition comprises:
a front side of the swimming pool cleaning robot being parallel or substantially parallel to a tangent line of the wall of the swimming pool, wherein the front side of the swimming pool cleaning robot is a side in the front of the swimming pool cleaning robot in a forward direction of the swimming pool cleaning robot.

13. The swimming pool edge cleaning method according to claim 10, wherein the controlling the swimming pool cleaning robot to move backward relative to the wall of the swimming pool until the spacing distance between the swimming pool cleaning robot and the wall of the swimming pool is sufficient for the swimming pool cleaning robot to perform the U-turn motion comprises:
controlling the swimming pool cleaning robot to move backward straight relative to the wall of the swimming pool based on a posture of the swimming pool cleaning robot after colliding with the wall of the swimming pool or the posture after completion of the fishtail relative to the wall of the swimming pool.

14. The swimming pool edge cleaning method according to claim 9, wherein the controlling the swimming pool cleaning robot to perform the U-turn relative to the wall of the swimming pool until the U-turn orientation of the swimming pool cleaning robot after the completion of the U-turn is opposite to the preset orientation comprises:
controlling the swimming pool cleaning robot to perform a differential motion based on a posture after moving backward, to perform the U-turn relative to the wall of the swimming pool until the U-turn orientation of the swimming pool cleaning robot is opposite to the preset orientation.

15. The swimming pool edge cleaning method according to claim 14, wherein the controlling the swimming pool cleaning robot to perform the differential motion based on the posture after moving backward, to perform the U-turn relative to the wall of the swimming pool until the U-turn orientation of the swimming pool cleaning robot is opposite to the preset orientation comprises:
controlling the swimming pool cleaning robot to perform a differential forward motion based on the posture after moving backward, to perform the U-turn relative to the wall of the swimming pool; or
controlling the swimming pool cleaning robot to perform the differential forward motion based on the posture after moving backward, to turn relative to the wall of the swimming pool, and controlling the swimming pool cleaning robot to perform a differential backward motion based on a posture after turning until the U-turn orientation of the swimming pool cleaning robot is opposite to the preset orientation.

16. The swimming pool edge cleaning method according to claim 9, wherein the method further comprises:
updating the U-turn orientation of the swimming pool cleaning robot as the preset orientation; and
returning to and continuing with the step of controlling the swimming pool cleaning robot to move toward the wall of the swimming pool based on the preset orientation until the swimming pool cleaning robot collides with the wall of the swimming pool.

17. An electronic device, comprising:
a processor; and
a memory storing a program,
wherein the program comprises instructions that, when executed by the processor, cause the processor to perform a swimming pool edge cleaning method, the swimming pool edge cleaning method comprising:
controlling, based on a wall of a swimming pool corresponding to an edge position to be cleaned, a swimming pool cleaning robot to perform a wall collision U-turn motion for the wall of the swimming pool corresponding to the edge position to be cleaned; and
cleaning the edge position to be cleaned during the performing of the wall collision U-turn motion,
wherein the wall collision U-turn motion is performed using a wall collision U-turning method for the swimming pool cleaning robot, the wall collision U-turning method comprising:
controlling the swimming pool cleaning robot to move toward the wall of the swimming pool based on a preset orientation until the swimming pool cleaning robot collides with the wall of the swimming pool;
controlling the swimming pool cleaning robot to move backward relative to the wall of the swimming pool until a spacing distance between the swimming pool cleaning robot and the wall of the swimming pool is sufficient for the swimming pool cleaning robot to perform a U-turn motion; and
controlling the swimming pool cleaning robot to perform a U-turn relative to the wall of the swimming pool until a U-turn orientation of the swimming pool cleaning robot after completion of the U-turn is opposite to the preset orientation.

18. The electronic device according to claim 17, wherein the controlling the swimming pool cleaning robot to move toward the wall of the swimming pool based on the preset orientation until the swimming pool cleaning robot collides with the wall of the swimming pool comprises:
controlling the swimming pool cleaning robot to move toward a direction of approaching the wall of the swimming pool relative to a bottom of the swimming pool based on the preset orientation until the swimming pool cleaning robot collides with the wall of the swimming pool.

19. The electronic device according to claim 18, wherein after the step of controlling the swimming pool cleaning robot to collide with the wall of the swimming pool, the method further comprises:
detecting a position of the swimming pool cleaning robot relative to the wall of the swimming pool; and
when the position of the swimming pool cleaning robot relative to the wall of the swimming pool does not satisfy a preset condition, controlling the swimming pool cleaning robot to fishtail relative to the wall of the swimming pool until the position of the swimming pool cleaning robot relative to the wall of the swimming pool satisfies the preset condition.

20. The electronic device according to claim 19, wherein the position of the swimming pool cleaning robot relative to the wall of the swimming pool satisfying the preset condition comprises:
a front side of the swimming pool cleaning robot being parallel or substantially parallel to a tangent line of the wall of the swimming pool, wherein the front side of the swimming pool cleaning robot is a side in the front of the swimming pool cleaning robot in a forward direction of the swimming pool cleaning robot.
